(19) United States
(12) Patent Application Publication
(10) Pub. No.: US 2008/0144583 A1
(43) Pub. Date: Jun. 19, 2008

(54) Adaptive Frame Synchronization in a Universal Mobile Telephone System Receiver

(76) Inventors: Louis Robert Litwin, Plainsboro, NJ (US); Joshua Lawrence Koslov, Hopewell, NJ (US)

Correspondence Address: Joseph J. Laks;Thomson Licensing LLC, 2 Independence Way, Patent Operations, PO Box 5312, PRINCETON, NJ, 08543, US

(21) Appl. No.: 10/566,877

(22) PCT Filed: Aug. 4, 2003
(86) PCT No.: PCT/US03/24348

§ 371 Date: Feb. 2, 2006

(51) Int. Cl. H04J 3/06

(52) U.S. Cl. 370/336

(57) ABSTRACT

A Universal Mobile Telephone System (UMTS) receiver performs slot synchronization using a received primary synchronization channel (PSCH). Subsequent to completion of slot synchronization, the UMTS receiver adaptively controls the duration of processing of the secondary synchronization channel (SSCH) for determining frame synchronization.

### BACKGROUND OF THE INVENTION

The present invention generally relates to wireless receiving devices, and more particularly, to user equipment (UE) in a spread-spectrum based wireless system such as the Universal Mobile Telephone System (UMTS).

The basic unit of time in UMTS radio signals is a 10 milli-second (ms) radio frame, which is divided into 15 slots of 2560 chips each. UMTS radio signals from a cell (or base station) to a UMTS receiver are “downlink signals,” while radio signals in the reverse direction are termed “uplink signals.” When a UMTS receiver is first turned on, the UMTS receiver performs a “cell search” to search for a cell to communicate with. In particular, and as described below, the UMTS receiver initially looks for a downlink synchronization channel (SCH) transmitted from the cell to synchronize thereto at the slot and frame levels, and to determine the particular scrambling code group of the cell. Only after a successful cell search can voice/data communications begin.

With respect to the cell search, the SCH is a sparse downlink channel that is only active during the first 256 chips of each slot. The SCH is made up of two subchannels, the Primary SCH (PSCH) and the Secondary SCH (SSCH). The PSCH 256 chip sequence, or PSCH code, is the same in all slots of the SCH for all cells. In contrast, the SSCH 256 chip sequence, or SSCH code, may be different in each of the 15 slots of a radio frame and is used to identify one of 64 possible scrambling code groups. In other words, each radio frame of the SCH repeats a scrambling code group sequence associated with the respective transmitting cell. Each SSCH code is taken from an alphabet of 16 possible SSCH codes.

As part of the cell search, the UMTS receiver first uses the PSCH to achieve slot synchronization. In this regard, the UMTS receiver correlates received samples of the received PSCH against the known PSCH 256 chip sequence (which is the same for all slots) and, based on the location of the correlation peak, determines a slot reference time. Once the slot reference time is determined, the UMTS receiver is slot synchronized and can determine when each slot starts in a received radio frame.

After slot synchronization, the UMTS receiver ceases processing of the PSCH and begins processing the SSCH. In particular, the UMTS receiver correlates the particular sequence of 15 SSCH codes in a received radio frame against known sequences to achieve frame synchronization and to determine the scrambling code group of the cell. Identification of the scrambling code group then enables the UMTS receiver to descramble all of the other downlink channels of the cell (e.g., the Common Pilot Channel (CPICH)) for voice/data communications to begin.

Unfortunately, the above-described SSCH portion of the cell search process is the most time consuming part. In particular, because of the low signal-to-noise ratios in which a UMTS system may operate, a UMTS receiver processes a predefined number of received radio frames, e.g., 10 to 20, in order to get a good estimate of the transmitted sequence of 15 SSCH codes from the cell. As such, since each radio frame is 10 ms long, a user may experience a delay on the order of at least 100 to 200 ms before voice/data communications can begin.

### SUMMARY OF THE INVENTION

As described above, a UMTS receiver performs the SSCH portion of the cell search by processing a predefined number of received radio frames. However, we have observed that—channel conditions permitting—the UMTS receiver may be able to acquire frame synchronization and successfully determine the scrambling code group after even processing one received radio frame. In other words, under some channel conditions, the UMTS receiver is wasting time by processing unnecessary received radio frames. Therefore, and in accordance with the principles of the invention, a UMTS receiver receives the SCH channel including the SSCH subchannel and adaptively controls the duration of SSCH-related processing for determining frame synchronization.

In an embodiment of the invention, the UMTS receiver is a part of the UMTS user equipment (UE). The UMTS receiver first performs slot synchronization using the PSCH and determines a peak correlation value associated with the received PSCH codes. After achieving slot synchronization, the UMTS receiver then determines the number of received radio frames required for determining frame synchronization as a function of the determined peak correlation value and, possibly, other of the correlation values. The UMTS receiver performs frame synchronization based on the determined number of received radio frames.

In accordance with another embodiment of the invention, the UMTS receiver is a part of the UMTS user equipment (UE). The UMTS receiver first performs slot synchronization using the PSCH. After achieving slot synchronization, the UMTS receiver initiates the frame synchronization process using the SSCH. During the frame synchronization process, the UMTS receiver checks if a scrambling code group can be determined after every received radio frame. If a scrambling code group can be determined, the UMTS receiver stops SSCH processing of further received radio frames and completes frame synchronization along with determination of the scrambling code.

### BRIEF DESCRIPTION OF THE DRAWINGS

FIG. 1 shows a portion of an illustrative wireless communications system in accordance with the principles of the invention;

FIGS. 2 and 3 show illustrative embodiments of a wireless receiver in accordance with the principles of the invention;

FIG. 4 shows an illustrative flow chart in accordance with the principles of the invention;

FIG. 5 shows an illustrative frame table in accordance with the principles of the invention;

FIG. 6 shows an illustrative pseudo code implementation in accordance with the principles of the invention;

FIGS. 7 and 8 show alternative implementations in accordance with the principles of the invention; and

FIGS. 9 and 10 show other illustrative flow charts in accordance with the principles of the invention.

### DETAILED DESCRIPTION

Other than the inventive concept, the elements shown in the figures are well known and will not be described in detail. Also, familiarity with UMTS-based wireless communications systems is assumed and is not described in detail herein. For example, other than the inventive concept, spread spectrum transmission and reception, cells (base stations), user equipment (UE), downlink channels, uplink channels and RAKE receivers are well known and not described herein. In addition, the inventive concept may be implemented using conventional programming techniques, which, as such, will not be described herein. Finally, like-numbers on the figures represent similar elements.

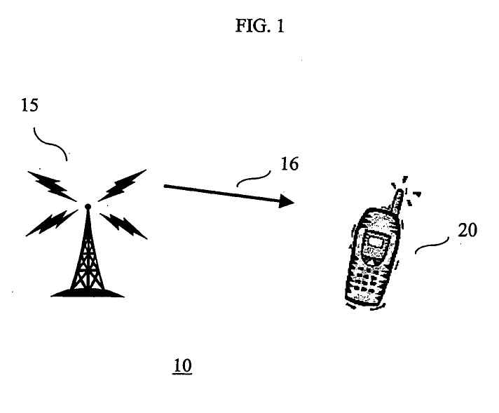

An illustrative portion of a UMTS wireless communications system 10 in accordance with the principles of the invention is shown in FIG. 1. Cell (or base station) 15 broadcasts a downlink synchronization channel (SCH) signal 16 including the above-mentioned PSCH and SSCH subchannels. As noted earlier, the SCH signal 16 is used by UMTS User Equipment (UE) for synchronization purposes as a pre-condition to voice/data communications. For example, the UE processes the SCH signal during a “cell search” operation. In this example, UE 20, e.g., a cellular phone, initiates a cell search when, e.g., UE 20 is turned on, or powered up. The purposes of the cell search operation include (a) synchronization to cell transmissions at the slot and frame level of the UMTS radio frame, and (b) determination of the scrambling code group of the cell (e.g., cell 15). As described below, and in accordance with the principles of the invention, UE 20 adaptively controls the duration of processing of the SSCH portion of the SCH for determining frame synchronization. It should be noted that although the following examples illustrate the inventive concept in the context of this initial cell search, i.e., when UE 20 is turned on, the inventive concept is not so limited and is applicable to other instances of the cell search, e.g., when the UE is in an “idle mode.”

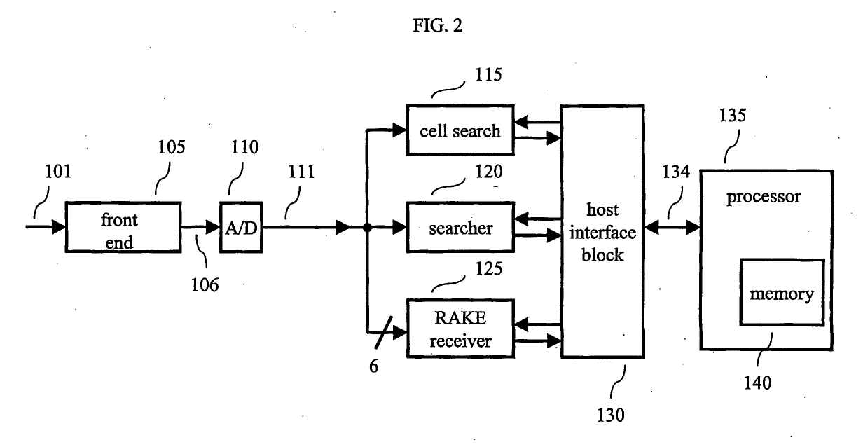

Turning now to FIG. 2, an illustrative block diagram of a portion of UE 20 in accordance with the principles of the invention is shown. UE 20 includes front end 105, analog-to-digital (A/D) converter 110, cell search element 115, searcher element 120, rake receiver 125, host interface block 130 and processor 135. It should also be noted that, other than the inventive concept, additional elements may be included within the blocks shown in FIG. 2 as known in the art but are not described herein for simplicity. For example, A/D converter 110 may include digital filters, buffers, etc.

Front end 105 receives a radio-frequency (RF) signal 101 transmitted from cell 15 (FIG. 1) via an antenna (not shown) and provides a base band analog signal 106 representing the PSCH and SSCH subchannels. Base band analog signal 106 is sampled by A/D converter 110, which provides a stream of received samples 111. The received samples 111 are available to three components: cell search element 115, searcher element 120 and rake receiver 125. Cell search element 115 processes the PSCH and SSCH subchannels in accordance with the principles of the invention as described further below. Subsequent to a successful cell search, searcher element 120 evaluates the received samples for the assignment of multipaths to each of the fingers of rake receiver 125, which, e.g., is capable of combining data from multiple paths in providing symbols for subsequent decoding by a decoder (not shown) to provide voice/data communications. Since only cell search element 115 is relevant to the inventive concept, search component 120 and rake receiver 125 are not described further herein. Host interface block 130 couples data between the three aforementioned components and processor 135, which, in this context, receives the results from cell search component 115 via signaling 134. Processor 135 is illustratively a stored-program controller processor, e.g., a microprocessor and includes memory 140 for storing programs and data.

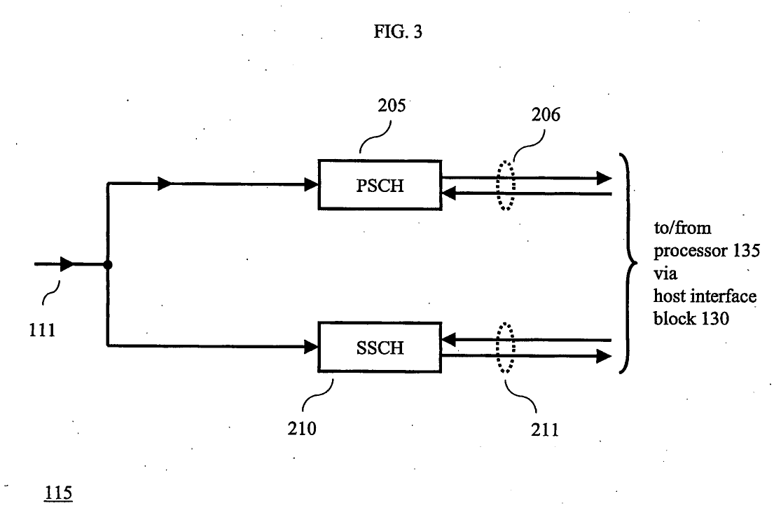

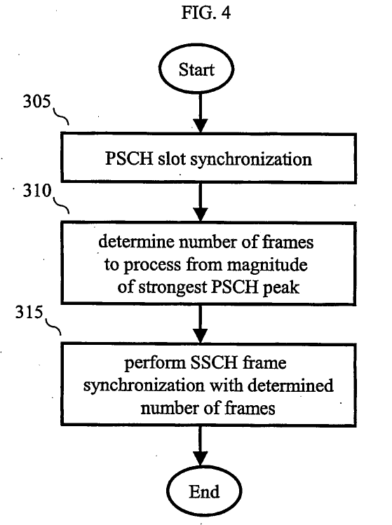

Turning now to FIG. 3, an illustrative block diagram of cell search element 115 is shown. Cell search element 115 includes PSCH element 205 and SSCH element 210. Reference should now also be made to FIG. 4, which shows an illustrative flow chart in accordance with the principles of the invention for processing the downlink PSCH and SSCH subchannels with cell search element 115 of FIG. 3. Processor 135 of UE 20 initiates the cell search in step 305 attempting to achieve slot synchronization by processing the downlink PSCH subchannel in step 305. In particular, processor 135 activates PSCH element 205, via signaling 206, to process the received samples 111 as known in the art. For example, since the downlink PSCH subchannel is a known PSCH 256 chip sequence, or PSCH code, that occurs periodically (i.e., repeats in every slot of the downlink SCH signal), PSCH element 205 correlates the received samples 111 against the PSCH code and provides an associated peak correlation value. In this regard, PSCH element 205 comprises a matched filter and a buffer (both not shown) that stores the output signal of the matched filter. PSCH element 205 provides the peak correlation value to processor 135 via signaling 206. This peak correlation value may be averaged over several slots of a received radio frame(s), e.g., between four and twenty slots, to decrease the probability of a “false lock.” (Since PSCH synchronization uses several slots—not frames—it is much quicker than the above-described SSCH frame synchronization of the prior art.) If the peak correlation value is not greater than a predefined threshold, processor 135 controls PSCH element 305 to continue processing any received signals to continue to look for a cell. However, if the peak correlation value is greater than a predefined threshold, UE 20 completes slot synchronization. An alternative method is to deem slot synchronization complete when the peak correlation value exceeds the next highest correlation value by a predefined additive or multiplicative factor.

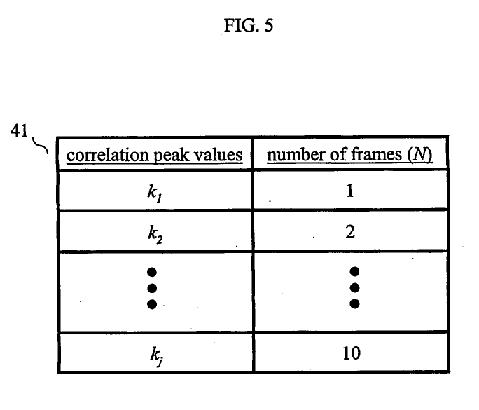

In step 310, and in accordance with the principles of the invention, processor 135 then adaptively determines the duration of the following SSCH processing as a function of the peak correlation value obtained from slot acquisition. In particular, processor 135 determines the number of received radio frames to process for frame synchronization as a function of the peak correlation value determined in the execution of step 305. In other words, the number of frame iterations for SSCH processing is based, e.g., on the strength of the PSCH correlation peak, which is used as a representation of the condition of the communications channel. Although any function can be used, illustratively, the number of frame iterations required for SSCH processing can be considered as being inversely proportional to the magnitude of the primary SCH correlation peak. For example, if the value of the PSCH correlation peak is very strong, above a predefined level, the SSCH processing uses only one frame worth of data; while if the value of the PSCH correlation peak is a little weaker, perhaps two frames are processed, and so on. In this regard, processor 135 uses an illustrative frame number table, or equivalent, to a priori associate PSCH correlation peak values with a required number of frames, N, for SSCH processing. Such an illustrative table 41 is shown in FIG. 5. Table 41 is illustratively stored in memory 140 of UE 20. Each row of table 41 associates a PSCH correlation peak value, kᵢ, with a number of frames, N, required for SSCH processing, where kᵢ>kᵢ₊₁. For example, in step 310, if the correlation peak value is greater than or equal to k₁, then processor 135 controls SSCH processing to use only one received frame (N=1). It should be noted that the actual correlation peak values and associated number of frames, N, are determined empirically and not described herein. As such, table 41 may include any number of rows depending on the empirically observed efficiencies in SSCH processing. It should be noted that other variations are possible, e.g., the number of frames, N, may be determined as a function of a plurality of correlation values, which may, or may not, include the peak correlation value.

Referring back to FIG. 4, once the number of received frames to process has been determined, processor 135 enables SSCH element 210 to process the received samples 111 for the determined number of frames, N, in step 315. SSCH element 210 is coupled with processor 135, via signaling 211, and correlates the particular sequence of 15 SSCH codes in a received radio frame against known sequences for use in achieving frame synchronization and for use in determining the scrambling code group of the cell (here, the scrambling code group associated with cell 15). In accordance with the principles of the invention, the SSCH processing is performed on the above-determined number, N, of received radio frames to average correlations over successive frames of data in order to get a robust estimate of the received 15 SSCH code sequence. Obviously, should N=1, then there are no successive frames. It should also be noted that, for simplicity, error conditions are not shown in the flow charts described herein. For example, should UE 20 lose slot synchronization while attempting frame synchronization, the above-described cell search is, unfortunately, restarted.

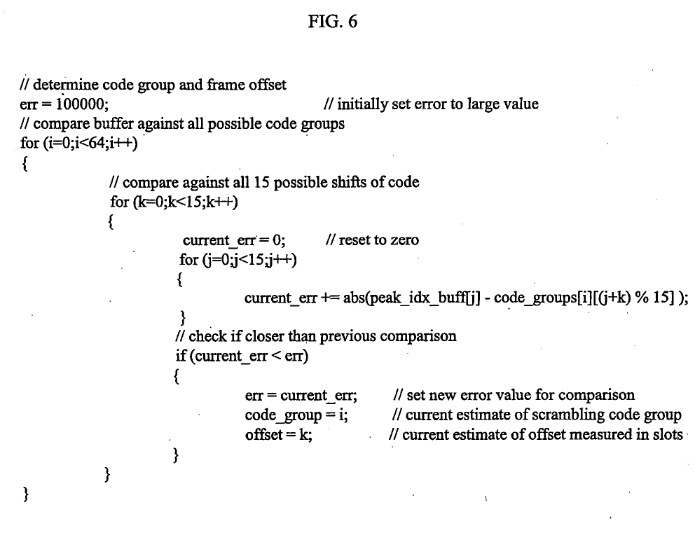

Other than the inventive concept, step 315 corresponds to SSCH processing as known in the art and is illustratively performed by SSCH element 210 and processor 135 of FIGS. 2 and 3, respectively. As background, UE 20 must determine which one of 64 scrambling code groups is being used by cell 15, where each scrambling code group is identified by a particular sequence of 15 SSCH codes. As used herein, the 64 scrambling code groups form a set of scrambling code groups. In forming a scrambling code group, each SSCH code, or symbol, is taken from an alphabet of 16 symbols, e.g., 1 to 16. As such, an illustrative scrambling code group, e.g., Group 1, may include the following 15 SSCH symbols:
[1 2 8 9 10 15 8 10 16 2 7 15 7 16].
   While another scrambling code group, e.g., Group 2, may include the following 15 SSCH symbols:
[1 1 5 16 7 3 14 16 3 10 5 12 14 12 10].
   However, since frame synchronization has not yet been achieved, a particular received sequence of 15 SSCH codes may be shifted in position from the respective scrambling code group. In this regard, in UMTS the scrambling code groups are defined a priori such that their cyclic-shifts are unique, i.e., a cyclic shift of any scrambling code group is not equivalent to any other scrambling code group. Therefore, since frame synchronization is not yet achieved, the received sequence of 15 SSCH codes are compared to all 15 possible cyclic shifts of all 64 possible scrambling code groups to identify the received scrambling code group and to determine the frame offset for acquiring frame synchronization from the cyclic shift. (It should be noted that a cyclic shift includes a zero shift, i.e., there is no actual shift in the scrambling code group sequence.) This results in a comparison of (64)(15)=960 possible sequences and is typically done in software in the form of nested loops for the 64 possible scrambling code groups and the 15 possible shifts within each scrambling code group. An illustrative pseudo code implementation for comparing a received sequence of 15 SSCH codes to all 15 possible cyclic shifts of all 64 possible scrambling code groups to identify the received scrambling code group and to determine the frame offset is shown in FIG. 6. In FIG. 6, it should be noted that the comparison between the parameter peak_idx_buff (the received samples) and the parameter code_groups (a stored lookup table of 15 values of all 64 possible code groups) is performed (64)(15)(15)=14400 times.

Once SSCH processing is successfully completed in step 315, the scrambling code group of cell 15 is identified which enables UE 20 to descramble all of the other downlink channels of the cell (including, e.g., the Common Pilot Channel (CPICH), which is used for frequency synchronization and also to determine the actual scrambling code for the cell from the identified scrambling code group) and voice/data communications can begin.

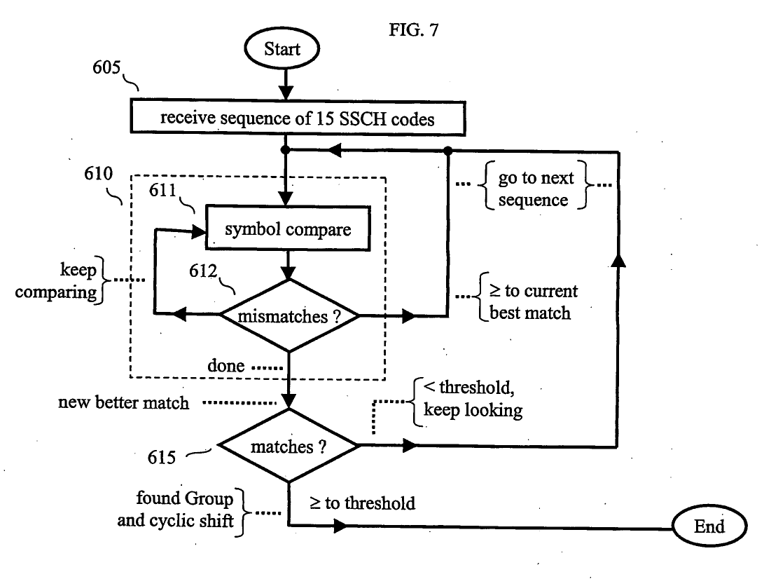

As can be observed from above, the amount of processing to compare a received sequence of 15 SSCH codes to all 15 possible cyclic shifts of all 64 possible scrambling code groups is rather large. However, and in accordance with an aspect of the invention, the amount of processing can be reduced by breaking out of the nested loops when a predefined number of matches, or mismatches, for a given scrambling code group and shift is encountered. An illustrative flow chart of such an alternative implementation is shown in FIG. 7. With respect to this implementation, the following data is tracked by processor 135:
target_sequence—a particular cyclic shift of a particular scrambling code group, i.e., one of the 960 possible sequences;
tentative_best_match—the scrambling code group sequence that is the current best match to the received sequence, initially set to null;
best_mismatches—the number of mismatches between the tentative best match an the received sequence, initially set to a value of 15;
best_matches—the number of matches between the tentative best match and the received sequence, initially set to a value of 0;
mismatches—the current number of mismatches between the received sequence and the target_sequence; initially set to a value of 0 at the start of each comparison; and
matches—the current number of matches between the received sequence and the target_sequence; initially set to a value of 0 at the start of each comparison.
   In step 605, a sequence of 15 SSCH codes is received for processing. Step 610 represents a comparison loop (hereafter loop 610) including steps 611 and 612. In step 611, a symbol of the received sequence is compared to a corresponding symbol of a target_sequence (one of the above-mentioned 960 possible sequences). As each symbol position is processed, the respective variables mismatches and matches are updated as appropriate. For example, if a particular comparison between a received symbol and a respective symbol of the target_sequence does not match, then the value of mismatches is incremented. Similarly, if there is a match, the value of matches is incremented. In step 612, the current value of mismatches is compared to the value of best_mismatches after every symbol comparison. If the value of mismatches is greater than, or equal to, the value of best_mismatches, then processor 135 breaks out of loop 610 and begins a new comparison of the received sequence to the next possible sequence, i.e., a new target_sequence. Since a new comparison is begun, the variables of matches and mismatches are reset to a value of 0. In other words, the current search, or comparison, is abandoned when the number of mismatches is equal to the mismatches for the current best match. This saves processing time. In particular, if a given received sequence has the same number of mismatches as a previous best match sequence, then the current comparison will not yield a better match, i.e., additional comparisons will not provide any additional information.

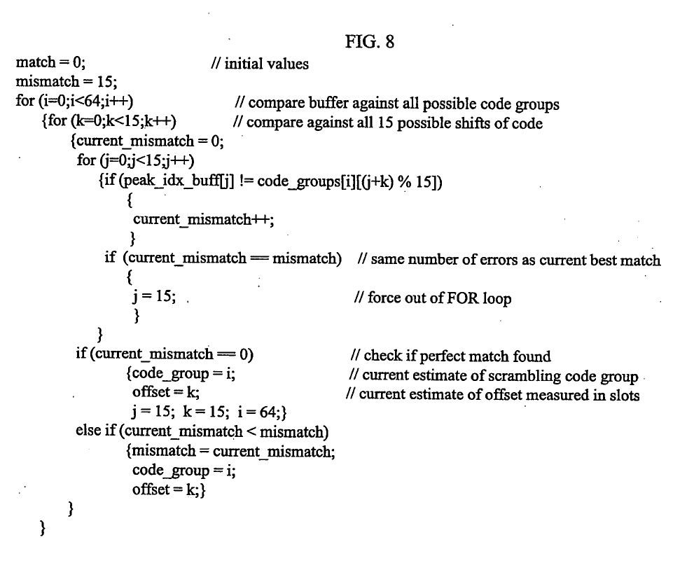

On the other hand, when loop 610 finishes a comparison between the received sequence and the target_sequence without breaking out of the loop—a new better match has been found. In this case, the variable tentative_best_match is updated with the target_sequence information (both as to scrambling code group and cyclic offset), the variable best_mismatches is updated with the value of mismatches and the value of best_matches is updated with the value of matches. In step 615, a comparison of the value of best_matches is made to a predefined threshold. If the value of best_matches is less than the predefined threshold, then comparisons to possible sequences continue in loop 610, as described above. However, if the value of best_matches is greater than, or equal to, the predefined threshold, then the tentative_best match is deemed to be the received scrambling code group and the associated cyclic shift is used for determining the frame offset. The predefined threshold can be set to, e.g., 15, which represents a perfect match; or the predefined threshold can be set to a lower value, e.g., 10 matches. The use of fewer than 15 matches may be preferable under poor signal-to-noise ratio conditions since it might not be possible to get a perfect match. Such a user-defined threshold less than 15 should be chosen such that it is high enough to guarantee, with a certain probability of success, that the wrong sequence will not be chosen by accident. An illustrative pseudo code implementation of the method of FIG. 7 is shown in FIG. 8.

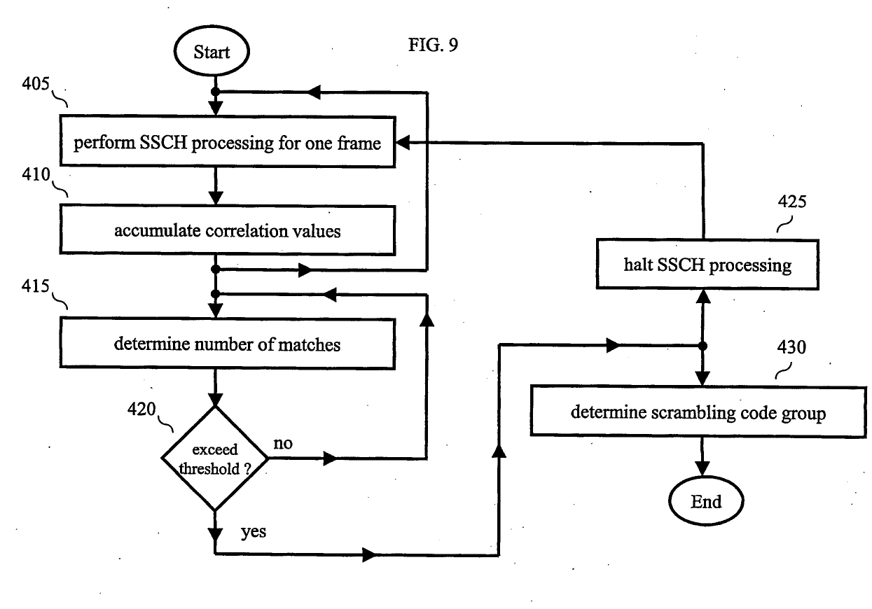

As described above, processor 135 adaptively determines the duration of the following SSCH processing as a function of the peak correlation value obtained from slot acquisition. In the embodiment described above, processor 135 determines the number of frames, N, to process. However, other alternatives are possible in accordance with the principles of the invention. Turning now to FIG. 9, another illustrative embodiment is shown. In this illustrative embodiment, accumulated data representing the sequence of 15 SSCH codes is examined after every frame iteration. If there are enough matches to identify a particular 15 SSCH code sequence, then SSCH processing is halted by processor 135. As such, SSCH processing may be halted even after one received radio frame is processed. In particular, after the above-described acquisition of slot synchronization (such as represented by step 305 of FIG. 4), processor 135 enables SSCH processing. In step 405 of FIG. 9, SSCH element 210 processes received radio frames, one frame at a time, as described above. As a result of this processing, and as each successive frame is processed, SSCH element 210 accumulates correlation values with respect to the received sequence of 15 SSCH codes over time in step 410. SSCH element 210 continues to process each received frame and accumulate data over time in steps 405 and 410 until halted by processor 135 (described below). In step 415, processor 135 determines the number of matches between the SSCH codes represented by the accumulated correlation values (the possible scrambling code group) and each one of the 64 scrambling code groups of the scrambling code group set. For example, if the accumulated correlation values from step 410 are representative of the following received SSCH sequence (the possible scrambling code group):
[1 1 2 8 9 5 5 5 5 5 5 5 5 5 5],
   then there would be five matches associated with scrambling code Group 1 and only two matches associate with scrambling code Group 2 (both Group 1 and Group 2 were illustratively defined earlier).

Continuing with the flow chart of FIG. 9, in step 420, processor 135 determines if the number of matches exceed a predefined threshold, e.g., at least 13 SSCH codes of a scrambling code group of the scrambling code group set match out a maximum of 15 possible matches. If none of the scrambling code groups of the scrambling code group set have an associated number of matches exceeding the predefined threshold, then processor 135 continues the process in step 415 and examines the accumulated correlation values as updated after the next received frame is processed by SSCH element 210. However, if the number of matches for one of the scrambling code groups of the scrambling code group set exceeds the predefined threshold, SSCH processing is halted in step 425 and that scrambling code group from the scrambling code group set is selected as the scrambling code group in step 430. As before, once SSCH processing is completed in step 430 and the scrambling code group of cell 15 is identified, UE 20 can descramble all of the other downlink channels of the cell (including, e.g., the Common Pilot Channel (CPICH), which is used for frequency synchronization and also to determine the actual scrambling code for the cell from the identified scrambling code group) and voice/data communications can begin.

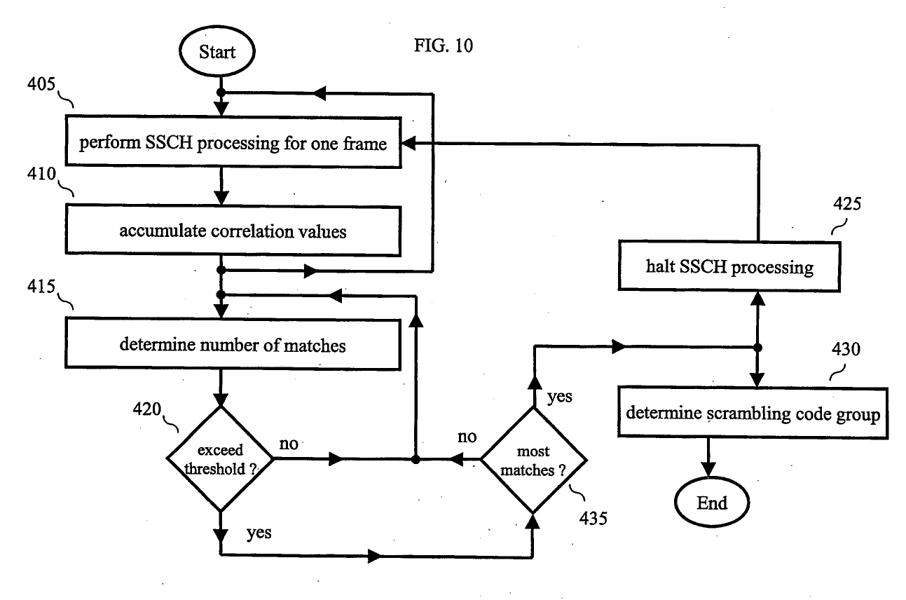

It should be observed from FIG. 9 that it may be the case that multiple scrambling code groups may have the same number of matches. For example, assume scrambling code group 5 is:
[1 2 3 4 5 6 7 8 9 10 11 12 13 14 15],
   scrambling code group 7 is:
[15 14 13 12 11 10 9 8 7 6 5 4 3 2 1], and
   the accumulated correlation values from step 410 are representative of the following received SSCH sequence (the possible scrambling code group):
[1 2 3 4 5 5 5 5 5 5 5 4 3 2 1].
   If the threshold for the predefined number of matches in step 420 is illustratively set to five, then there are five matches for both scrambling code group 5 and scrambling code group 7 of the scrambling code group set. In this case, the selection of a particular scrambling code group is unreliable. The flow chart shown in FIG. 10 adds an additional step 435, which, once the predefined threshold has been exceeded, selects that scrambling code group from the scrambling code group set with the most matches. If no scrambling code group has the most matches, processing continues as described above with step 415. However, if one scrambling code group does have the most matches, SSCH processing is halted in step 425 and that scrambling code group of the scrambling code group set is selected as the scrambling code group in step 430.

As described above, and in accordance with the principles of the invention, a wireless receiver adaptively determines the duration of SSCH processing to reduce the number of received frames that are processed such that, ideally, a minimum number of received frames are processed to achieve frame synchronization. Although described in the context of the initial cell search process, the inventive concept is applicable to any portion of wireless operation in which a downlink channel, such as the SSCH subchannel, is processed in the presence of changing channel conditions.

The foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied on one or more integrated circuits (ICs) and/or in one or more stored program-controlled processors (e.g., a microprocessor or digital signal processor (DSP)). Similarly, although illustrated in the context of a UMTS-based system, the inventive concept is applicable to any communications system that processes signals in the presence of changing channel conditions. It is therefore to be understood that numerous modifications may be made to the illustrative embodiments and that other arrangements may be devised without departing from the spirit and scope of the present invention as defined by the appended claims.

1. A method for use in a wireless receiver, comprising:
processing a first synchronization channel of a received wireless signal to acquire slot synchronization; and
adaptively controlling a duration for processing a second synchronization channel of the received wireless signal to acquire frame synchronization.

2. The method of claim 1, wherein the first synchronization channel is a primary synchronization subchannel (PSCH) and the second synchronization channel is a secondary synchronization subchannel (SSCH) of a universal mobile telephone system (UMTS).

3. The method of claim 1, wherein the step of processing the first synchronization channel includes the step of providing a peak correlation value associated with the first synchronization channel.

4. The method of claim 3, wherein the adaptively controlling step includes the steps of:
determining a number of received frames of the received wireless signal as a function of the peak correlation value; and
processing the second synchronization channel over the determined number of frames to acquire frame synchronization.

5. The method of claim 4, wherein the processing the second synchronization channel includes the steps of:
comparing an estimated received sequence to each one of a plurality of possible received sequences, each sequence including a plurality of symbols; and
after each comparison to one of the plurality of possible sequences, identifying one of the plurality of possible sequences as a possible best match;
wherein, in the comparing step, if a number of mismatches for a current comparison is greater than or equal to a number of mismatches associated with the possible best match, the current comparison is abandoned and a new comparison is begun.

6. The method of claim 1, wherein the step of processing the first synchronization channel includes the step of providing multiple correlation values, including the peak correlation value, associated with the first synchronization channel.

7. The method of claim 6, wherein the adaptively controlling step includes the steps of:
determining a number of received frames of the received wireless signal as a function of the peak correlation value and at least one other value; and
processing the second synchronization channel over the determined number of frames to acquire frame synchronization.

8. The method of claim 7, wherein the step of processing the second synchronization channel includes the steps of:
correlating the received wireless signal to provide an estimate of a received sequence over the determined number of frames; and
comparing the estimated received sequence to each one of a plurality of expected received sequences to determine a number of matches thereto; and
if the number of matches to at least one of the plurality of expected received sequences exceeds a predefined threshold, breaking out of the step of processing the second synchronization channel.

9. The method of claim 1, wherein the adaptively controlling step includes the steps of:
processing the second synchronization channel to form cumulative data representing a possible scrambling code group comprising an M symbol sequence;
determining a number of matches between the M symbol sequence of the possible scrambling code group and each scrambling code group of a set of scrambling code groups; and
if the determined number of matches for at-least-one scrambling code group of the set of scrambling code groups exceeds a predefined value, selecting the at-least-one scrambling code group as the scrambling code group for use in acquiring frame synchronization.

10. The method of claim 9, wherein the selecting step includes the step of halting further processing of received frames in the received wireless signal.

11. The method of claim 9, wherein the selecting step includes the step of:
if more than one scrambling code group of the scrambling code group set exceeds the determined number of matches, selecting the scrambling code group with the most number of matches.

12. A method for use in a wireless receiver, comprising:
processing a first synchronization channel of a wireless signal, received from a wireless communications channel to acquire slot synchronization, for providing a signal representative of a condition of the wireless communications channel;
using a value of the signal for indexing into a table for determining a number of received frames; and
processing a second synchronization channel of the wireless signal over at least the determined number of received frames to acquire frame synchronization.

13. The method of claim 12, wherein the processing the second synchronization channel includes the steps of:
comparing an estimated received sequence to each one of a plurality of possible received sequences, each sequence including a plurality of symbols; and
after each comparison to one of the plurality of possible sequences, identifying one of the plurality of possible sequences as a possible best match;
wherein, in the comparing step, if a number of mismatches for a current comparison is greater than or equal to a number of mismatches associated with the possible best match, the current comparison is abandoned and a new comparison is begun.

14. Universal Mobile Telephone System (UMTS) equipment comprising:
a front end for receiving a wireless signal representing a sequence of frames and for providing a stream of received samples therefrom; and
a processor for adaptively controlling a duration for performing frame synchronization on the received samples.

15. The UMTS equipment of claim 14, further comprising:
a primary synchronization element operative on the received samples for acquiring slot synchronization to a primary synchronization signal of the received wireless signal and for providing a peak correlation value associated therewith; and
a secondary synchronization element operative on the received samples for acquiring frame synchronization to a secondary synchronization signal of the received wireless signal;
wherein the processor determines a number of frames for the secondary synchronization element to process for acquiring frame synchronization as a function of the peak correlation value.

16. The UMTS equipment of claim 15, wherein the processor determines the number of frames for the secondary synchronization element to process for acquiring frame synchronization as a function of the peak correlation value and at least one other correlation value.

17. The UMTS equipment of claim 14, further comprising:
a primary synchronization element operative on the received samples for acquiring slot synchronization to a primary synchronization signal of the received wireless signal; and
a secondary synchronization element operative on the received samples subsequent to slot synchronization for providing a possible scrambling code group comprising an M symbol sequence;
wherein the processor (a) determines a number of matches between the M symbol sequence of the possible scrambling code group and each scrambling code group of a set of scrambling code groups, and (b) if the determined number of matches for at-least-one scrambling code group of the set of scrambling code groups exceeds a predefined value, selects the at-least-one scrambling code group as the scrambling code group for use in acquiring frame synchronization.

18. The UMTS equipment of claim 17, wherein the processor halts further processing of received frames in the received wireless signal if the determined number of matches for at-least-one scrambling code group exceeds the predefined value.

19. The UMTS equipment of claim 17, wherein if more than one scrambling code group of the scrambling code group set exceeds the determined number of matches, the processor selects the scrambling code group with the most number of matches.

20. Universal Mobile Telephone System (UMTS) equipment comprising:
a front end for receiving a wireless signal representing a sequence of frames, each frame conveying a primary synchronization signal and a secondary synchronization signal;
a memory for storing a table for associating a number of received frames with a correlation value, the correlation value being associated with the received primary synchronization signal; and
a processor that limits processing of the secondary synchronization signal to the associated number of received frames.
